(19) United States
(12) Patent Application Publication
(10) Pub. No.: US 2014/0204007 A1
(43) Pub. Date: Jul. 24, 2014

(54) METHOD AND SYSTEM FOR LIQUID CRYSTAL DISPLAY COLOR OPTIMIZATION WITH SUB-PIXEL OPENINGS

(71) Applicant: Stefan Peana, Austin, TX (US)

(72) Inventor: Stefan Peana, Austin, TX (US)

(21) Appl. No.: 13/747,060

(22) Filed: Jan. 22, 2013

(51) Int. Cl. G09G 3/36

(52) U.S. Cl. CPC G09G 3/3607
USPC 345/88

(57) ABSTRACT

Systems and methods for liquid crystal display brightness and color optimization that includes configuring a sub-pixel of a LCD to allow light from a backlight to traverse the sub-pixel unfiltered to a display surface of the LCD. The method also includes determining a color primary based on the amount of light from the backlight that traverses the sub-pixel unfiltered. The color primary defines a portion of a color gamut available to the LCD, and the color gamut has a plurality of colors. The method further includes applying a color restoration algorithm to adjust the plurality of colors in the color gamut.

### TECHNICAL FIELD

The present disclosure relates in general to information handling systems, and more particularly to a method and system for liquid crystal display color optimization with sub-pixel openings.

### BACKGROUND

As the value and use of information continues to increase, individuals and businesses seek additional ways to process and store information. One option available to users may be information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information may be handled, how the information may be handled, how much information may be processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications.

Information handling systems may include a variety of hardware and/or software components that may be configured to process, store, and/or communicate information. Liquid crystal displays (LCDs) may be used to display and communicate information. LCDs may modulate light to create images using selectively transmissive and opaque portions of the display by passing electrical current through the liquid crystal material. LCDs may use a backlight positioned behind the LCD glass to illuminate through a panel of pixels. The LCD backlight may be one of the primary sources of power consumption in an information handling system and thus, power consumption of the backlight may be finite. To manage power consumption, the information handling system may manage display image output, such as, limiting image brightness, image color, or both.

### SUMMARY

In accordance with the teachings of the present disclosure, disadvantages and problems associated with liquid crystal display brightness and color optimization may be substantially reduced or eliminated.

In accordance with one embodiment of the present disclosure, a method is described for liquid crystal display (LCD) brightness and color optimization that includes configuring a sub-pixel of a LCD to allow light from a backlight to traverse the sub-pixel unfiltered to a display surface of the LCD. The method includes determining a color primary based on the amount of light from the backlight that traverses the sub-pixel unfiltered. The color primary defines a portion of a color gamut available to the LCD, and the color gamut has a plurality of colors. The method further includes applying a color restoration algorithm to adjust the plurality of colors in the color gamut.

In accordance with another embodiment of the present disclosure, a LCD includes a sub-pixel of the LCD configured to allow light from a backlight to traverse the sub-pixel unfiltered to a display surface of the LCD. The LCD also includes a processor configured to determine a color primary based on the amount of light from the backlight that traverses the sub-pixel unfiltered. Additionally, the color primary defines a portion of a color gamut available to the LCD, and the color gamut has a plurality of colors. The processor is further configured to apply a color restoration algorithm to adjust the plurality of colors in the color gamut.

In accordance with another embodiment of the present disclosure, an information handling system includes a LCD that has a sub-pixel configured to allow light from a backlight to traverse the sub-pixel unfiltered to a display surface of the LCD. The information handling system includes a memory and a processor communicatively coupled to the LCD and the memory. The information handling system also includes a computer-readable medium communicatively coupled to the processor and has stored thereon instructions configured to, when executed by the processor, determine a color primary based on the amount of light from the backlight that traverses the sub-pixel unfiltered. The color primary defines a portion of a color gamut available to the LCD, and the color gamut has a plurality of colors. The instructions are further configured to apply a color restoration algorithm to adjust the plurality of colors in the color gamut.

Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with certain embodiments of the present disclosure;

FIG. 2 illustrates an example xy chromaticity diagram for liquid crystal display (LCD) color optimization, in accordance with certain embodiments of the present disclosure;

FIG. 3 illustrates example red, green, and blue (RGB) sub-pixel opening configurations, in accordance with certain embodiments of the present disclosure;

FIG. 4 illustrates the impact of sub-pixel openings shown in an example configuration of FIG. 3 on image saturation and utilization of a color restoration algorithm, in accordance with certain embodiments of the present disclosure;

FIG. 5 illustrates an example xy chromaticity diagram for LCD color optimization utilizing a common factor (U) for sub-pixel openings, in accordance with certain embodiments of the present disclosure;

FIG. 6 illustrates an example impact of application of various common factors (U) for sub-pixel openings on saturation of an image and impact of utilization of a color restoration algorithm, in accordance with certain embodiments of the present disclosure; and

FIG. 7 illustrates a flow chart for an example method for LCD color optimization, in accordance with certain embodiments of the present disclosure.

### DETAILED DESCRIPTION

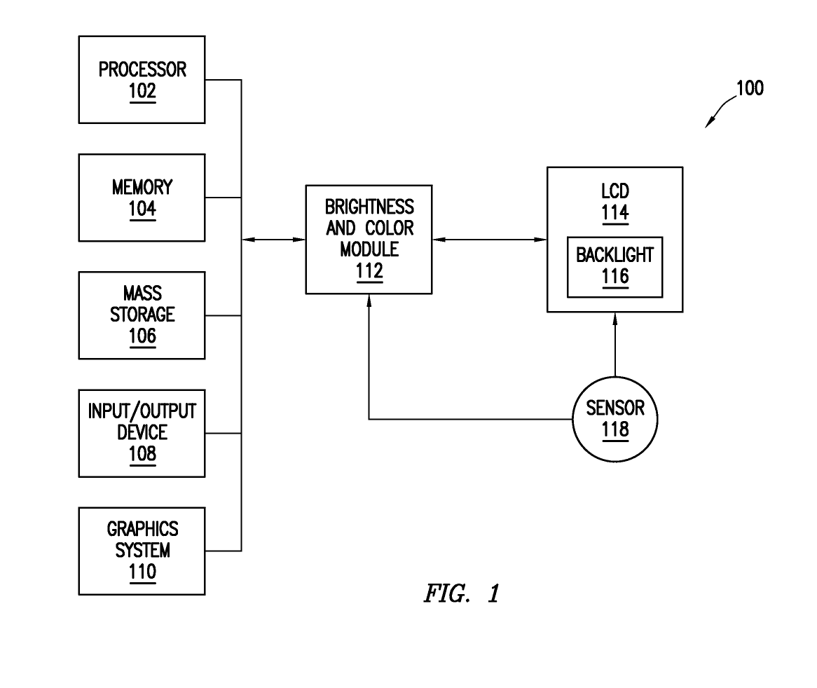

Preferred embodiments and their advantages are best understood by reference to FIGS. 1-7, wherein like numbers are used to indicate like and corresponding parts.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage resource, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such wires, optical fibers, microwaves, radio waves, and other electromagnetic and/or optical carriers; and/or any combination of the foregoing.

FIG. 1 illustrates a block diagram of an example information handling system 100, in accordance with certain embodiments of the present disclosure. Information handling system 100 may generally be operable to receive data from, and/or transmit data to, other information handling systems 100. In one embodiment, information handling system 100 may be a desktop computer, laptop computer, mobile wireless device, wireless communication device, and/or any other suitable computing device. In the same or alternative embodiments, information handling system 100 may be a server or a storage array configured to include multiple storage resources (e.g., hard drives) in order to manage large amounts of data. In some embodiments, information handling system 100 may include, among other suitable components, processor 102, memory 104, mass storage device 106, input-output device 108, graphics system 110, brightness and color module 112, liquid crystal display 114, and sensor 118.

Processor 102 may include any system, device, or apparatus operable to interpret and/or execute program instructions and/or process data. Processor 102 may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 102 may interpret and/or execute program instructions and/or process data stored in memory 104, mass storage device 106, and/or another component of system 100.

Memory 104 may be communicatively coupled to processor 102 and may include any system, device, or apparatus operable to retain program instructions or data for a period of time (e.g., computer-readable media). Memory 104 may include random access memory (RAM), electrically erasable programmable read-only memory (EEPROM), flash memory, magnetic storage, opto-magnetic storage, or any suitable selection and/or array of volatile or non-volatile memory that retains data after power to system 100 may be removed.

Mass storage device 106 may include one or more storage resources (or aggregations thereof) communicatively coupled to processor 102 and may include any system, device, or apparatus operable to retain program instructions or data for a period of time (e.g., computer-readable media). Mass storage device 106 may retain data after power to system 100 may be removed. Mass storage device 106 may include one or more hard disk drives (HDDs), magnetic tape libraries, optical disk drives, magneto-optical disk drives, compact disk drives, compact disk arrays, disk array controllers, solid state drives (SSDs), and/or any computer-readable medium operable to store data.

Input-output device 108 may be communicatively coupled to processor 102 and may include any instrumentality or aggregation of instrumentalities by which a user may interact with system 100 and its various information handling resources by facilitating input from a user allowing the user to manipulate system 100 and output to a user allowing system 100 to indicate effects of the user's manipulation. For example, input-output device 108 may permit a user to input data and/or instructions into system 100 (e.g., via a keyboard, pointing device, and/or other suitable means), and/or otherwise manipulate system 100 and its associated components. In these and other embodiments, input-output device 108 may include other user interface elements (e.g., a keypad, buttons, and/or switches placed in proximity to a display) allowing a user to provide input to system 100.

Graphics system 110 may be communicatively coupled to processor 102 and may include any system, device, or apparatus operable to receive and process video information. Graphics system 110 may additionally be operable to transmit digital video information to liquid crystal display (LCD) 114. Graphics system 110 may include any internal graphics capabilities including for example, but not limited to, integrated graphics or a graphics card. Graphics system 110 may include graphics drivers, graphics processors, and/or any other suitable components.

LCD 114 may be communicatively coupled to processor 102 and may include any instrumentality or aggregation of instrumentalities to display information to a user. For example, LCD 114 may include a display suitable for creating graphic images and/or alphanumeric characters recognizable to a user. In certain embodiments, LCD 114 may be an integral part of a chassis (not explicitly shown) and receive power from power supplies (not explicitly shown) of the chassis, rather than being coupled to the chassis via a cable. In some embodiments, LCD 114 may comprise a touch screen device capable of receiving user input, wherein a touch sensor may be mechanically coupled or overlaid upon the display and may comprise any system, apparatus, or device suitable for detecting the presence and/or location of a tactile touch, including, for example, a resistive sensor, capacitive sensor, surface acoustic wave sensor, projected capacitance sensor, infrared sensor, strain gauge sensor, optical imaging sensor, dispersive signal technology sensor, and/or acoustic pulse recognition sensor.

In some embodiments, LCD 114 may include an inverter, a processor, and/or any other suitable components. LCD 114 may modulate light to create images using selectively transmissive and opaque portions of the display by passing electrical current through a liquid crystal material. LCD 114 may include backlight 116. Backlight 116 may be any component configured to illuminate the liquid crystal material to provide a contrast between the light transmissive and opaque portions of LCD 114. Backlight 116 may be a cool cathode florescent light (CCFL), several light emitting diodes (LEDs), an electroluminescent panel (ELP), or any other suitable device.

LCD 114 may have a display surface that may include multiple pixels. Each pixel in LCD 114 may include liquid crystal molecules suspended between two transparent electrodes that are in turn sandwiched between two polarizing filters whose axes of transmission may be perpendicular to each other. By applying voltage to the transparent electrodes over each pixel, the corresponding liquid crystal molecules may be “twisted” by electrostatic forces that may allow varying degrees of light to pass through the polarizing filters. Each pixel may be composed of individual red, green, blue (RGB), and/or other color sub-pixels. In some embodiments, LCD 114 may be a white organic light-emitting diode (WOLED) display that may utilize a white organic layer in place of backlight 116.

Sensor 118 may be communicatively coupled to LCD 114 and/or brightness and color module 112 and may include any system, device, or apparatus operable to sense light and/or color. Sensor 118 may be a device to detect brightness levels of ambient light proximate to and/or remote from LCD 114, such as an ambient light sensor (ALS). In some embodiments, sensor 118 may be a device to detect the color of ambient light proximate to and/or remote from LCD 114. In another embodiment, sensor 118 may be configured to detect both brightness and color of the ambient light proximate to and/or remote from LCD 114. For example, sensor 118 may be a component of a camera or video device proximate to and/or remote from LCD 114. In yet another embodiment, sensor 118 may be configured in a confined area, such as a conference room, and may detect brightness and/or color in a particular section of the confined area or room. Sensor 118 may be further configured to transmit the sensed information to LCD 114, brightness and color module 112, and/or any other suitable component of system 100.

Brightness and color module 112 may be communicatively coupled to LCD 114, processor 102, graphics system 110, sensor 118, and/or any other suitable component of system 100. In some embodiments, brightness and color module 112 may perform brightness and/or color adjustments that may be reflected in LCD 114. In some embodiments, brightness and color module 112 may be implemented in, for example, any application, process, script, module, executable, executable program, server, executable object, library, function, or other suitable digital entity. Brightness and color module 112 may include logic or instructions for execution by a processor such as processor 102. The logic of instructions of brightness and color module 112 may be resident within a memory 104 or mass storage device 106 communicatively coupled to processor 104.

Brightness and color module 112 may be implemented by any suitable software, hardware, firmware, or combination thereof configured as described herein. Brightness and color module 112 may be implemented by any suitable set of files, instructions, or other digital information. Brightness and color module 112 may include a set of files or other information making up, for example, a virtual machine installation such as an operating system, a virtual deployment environment or a secured module such as a secured browser. Brightness and color module 112 may include such an installation to be installed and configured in the same way among multiple of information handling system 100. In some embodiments, brightness and color module 112 may be configured to control backlight 116 to manage power consumption of LCD 114.

In some embodiments, the diversity of software applications executed by system 100 may require LCD 114 to display information at high resolutions with corresponding brightness and color gamut modifications. High resolution displays may impact overall system 100 performance due to the additional processing requirements. For example, while better resolution and color gamut may be possible for a particular system, the system may not employ higher resolutions or larger color gamuts due to the corresponding increase of power consumption requirements. Therefore, optimization of resolution, brightness, and color for LCD 114 may be desired to maximize text and image legibility while taking into account the impact on overall system 100 power usage.

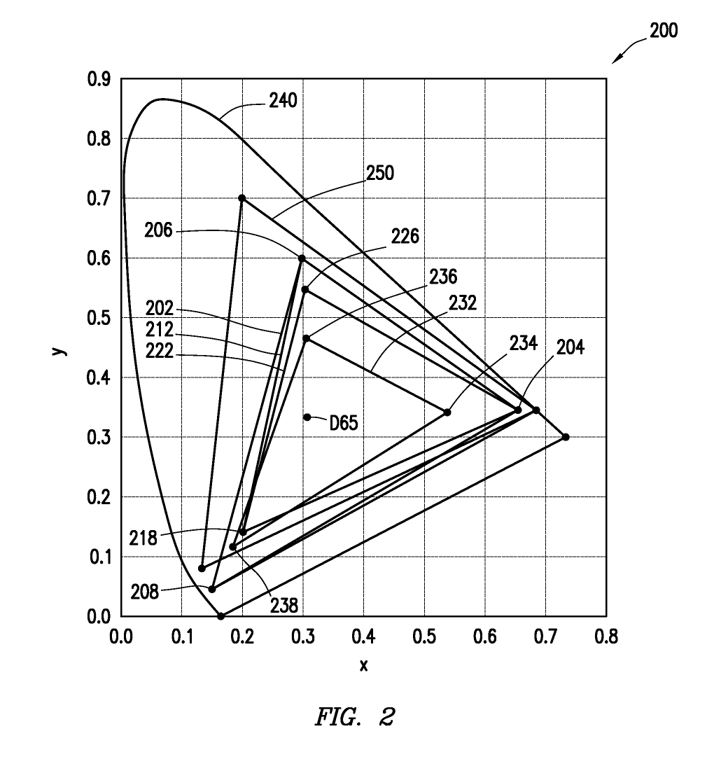

FIG. 2 illustrates an example xy chromaticity diagram 200 for LCD color optimization, in accordance with certain embodiments of the present disclosure. Conceptually, color may be divided into two components: brightness and chromaticity. Chromaticity may be expressed through the use of a chromaticity diagram, such as chromaticity diagram 200. Chromaticity diagram 200 may be based on a xy color coordinate method for expressing a color by chromaticity coordinates x and y. Coordinates x and y may be derived from the tristimulus values (XYZ) of colors. Tristimulus values of a particular color may indicate the amount of the three primary colors, e.g., red, blue, and green, in a tri-chromatic additive color model that are present in the color. Coordinates x and y may be determined by the equations:

$$x = \frac{X}{X + Y + Z} , y = \frac{Y}{X + Y + Z} .$$

In some embodiments, curved boundary 240 may represent the entire range, or “gamut,” of colors that may be available for a display, such as LCD 114. Color gamuts 202, 212, 222, and 232 may represent the edge of a particular range or gamut of colors available to and/or visible on a display. For example, color gamut 202 may be bounded by red primary 204, green primary 206, and blue primary 208. Color gamut 212 may be bounded by red primary 204, green primary 206, and blue primary 218. Color gamut 222 may be may be bounded by red primary 204, green primary 226, and blue primary 218. Color gamut 232 may be may be bounded by red primary 234, green primary 236, and blue primary 238. In some embodiments, D65 may be the point that commonly represents the color white.

In some embodiments, each of color gamuts 202, 212, 222, and 232 may be predefined by a user and/or a manufacturer. Color gamuts 202, 212, 222, and 232 may be adjustable or may be fixed. Although only four color gamuts, e.g., color gamuts 202, 212, 222, and 232, may be shown, more or fewer color gamuts may exist and may be defined. Further, although color gamuts are shown as a triangular shape with three vertices, any other suitable shape may be employed. For example, a quadrilateral or pentagon may be formed with vertices added for yellow and/or cyan.

In some embodiments, color gamut 202 may represent a standard red, green, blue (sRGB) color space of a display, such as LCD 114. The sRGB color space may be approximately 70% of the National Television System Committee (NTSC) standard color space 250. NTSC standard 250 may define the colorimeteric values, e.g., primary red, primary green, primary blue, and white point of analog color televisions. As higher resolution applications and devices are employed, larger color gamuts may be required. For example, in some embodiments, when an image is transferred from a higher resolution (e.g., approximately eight million pixels) display with a larger color gamut to a lower color gamut, a clipping process may be utilized to bring the image within the display color gamut capability. However, increases in color gamut may increase power consumption as increased processing may be required by a system.

Further, addition of an active sub-pixel to existing RGB sub-pixels may expand the color gamut available. For example, the addition of a yellow and/or cyan sub-pixel may expand the color gamut. However, the addition of a sub-pixel may be computationally intensive and may complicate LCD fabrication. Further, sub-pixel rendering may lead to display errors, such as, text artifacts. Thus, a system that may increase color gamut without an increase in power consumption and without the introduction of an additional sub-pixel may be advantageous.

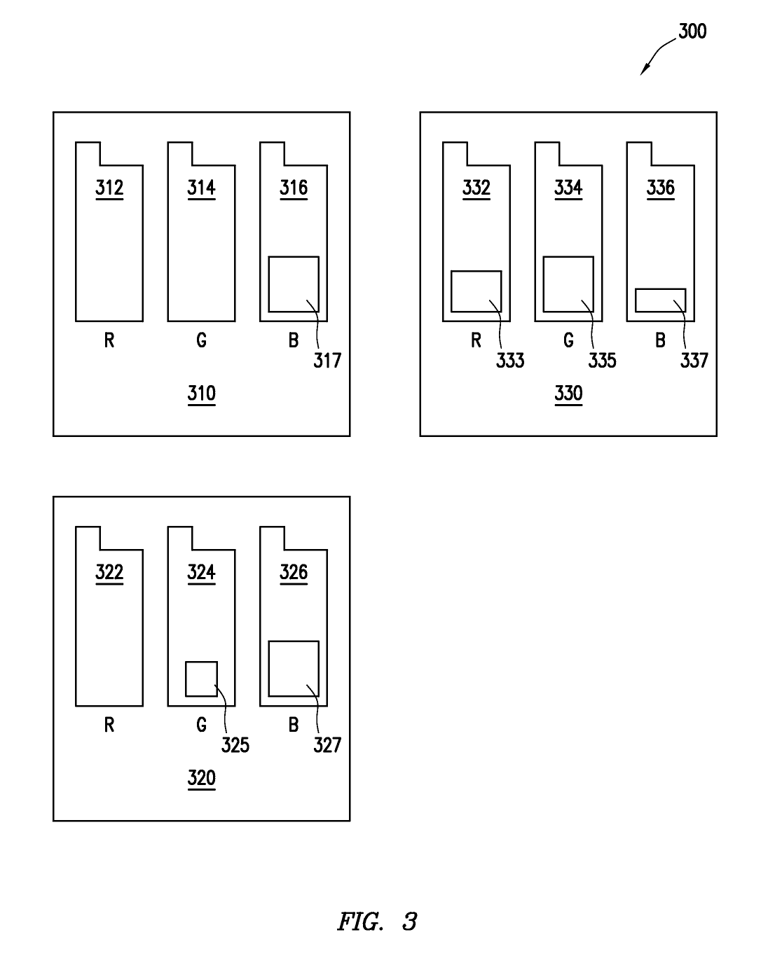

FIG. 3 illustrates example RGB sub-pixel opening configurations 300, in accordance with certain embodiments of the present disclosure. Each RGB sub-pixel arrangement 310, 320, and 330 may include red sub-pixel 312, 322, and 332, green sub-pixel 314, 324, and 334, and blue sub-pixel 316, 326, and 336, respectively. In some embodiments, selected RGB sub-pixels may include an opening or hole, e.g., opening 317, to allow the white light, e.g., D65 illuminant, from backlight 116, discussed with reference to FIG. 1, to pass through or traverse the sub-pixel to the display surface of LCD 114.

In some embodiments, sub-pixel openings may dilute each of the RGB colorants by the white of the D65 illuminant by a different factor for red (Uᵣ), green (U_{g}), and blue (U_{b}). Each of the respective factors may relate to the size in area of the opening in the respective sub-pixel. For example, Uᵣ=0.1 may correspond to an opening in the red sub-pixel of approximately ten percent of the total area of the red sub-pixel. The luminance of each of the sub-pixels with an opening may be based on the original RGB luminance values, e.g., L_{red}, L_{green}, and L_{blue}, the respective factors, e.g., Uᵣ, U_{g}, and U_{b}, and the luminance of white, L_{white}. The respective tristimulus values may be computed by calculating the luminance for each of the red, green, and blue sub-pixels using the following equations:

L Red Total=L_{red}*(1−Uᵣ)+L_{white}*Uᵣ

L Green Total=L_{green}*(1−U_{g})+L_{white}*U_{g}

L Blue Total=L_{blue}*(1−U_{b})+L_{white}*U_{b}

The luminance of the added white from the respective sub-pixel openings may be the luminance of red+green+blue shown by the equation:

L Pixel=L Red Total+L Green Total+L Blue Total.

In some embodiments, allowing additional white light to pass thorough a sub-pixel may de-saturate the original color. Thus, the color gamut may be reduced. A reduction in the color gamut may shift the color primaries to new locations. For example, arrangement 310 may include opening 317 in blue sub-pixel 316 of approximately thirty percent of the total area of blue sub-pixel 316, e.g., approximately U_{b}=0.3. With reference to FIG. 2, the corresponding color gamut reduction may be illustrated by the reduction between color gamut 202 and color gamut 212. For example, the blue primary may be reduced from blue primary 208 to blue primary 218.

As another example, sub-pixel arrangement 320 may include opening 327 in blue sub-pixel 326 of approximately thirty percent of the total area of blue sub-pixel 326, e.g., approximately U_{b}=0.3, and opening 325 in green sub-pixel 324 of approximately fifteen percent of the total area of green sub-pixel 324, e.g., approximately U_{g}=0.15. The corresponding reduction in color gamut may be represented by the reduction in color gamut between color gamut 202 and color gamut 222, shown in FIG. 2. For example, the blue primary may be reduced from blue primary 208 to blue primary 218, and the green primary may be reduced from green primary 206 to green primary 226.

As yet another example, sub-pixel arrangement 330 may include opening 333 in red sub-pixel 332 of approximately twenty percent of the total area of red sub-pixel 332, e.g., e.g., approximately Uᵣ=0.2, opening 335 in green sub-pixel 334 of approximately thirty percent of the total area of green sub-pixel 334, e.g., approximately U_{g}=0.3, and opening 337 in blue sub-pixel 336 of approximately ten percent of the total area of blue sub-pixel 336, e.g., approximately U_{b}=0.1. The corresponding reduction in color gamut may be represented by the reduction in color gamut between color gamut 202 and color gamut 232, shown in FIG. 2. For example, the red primary may be reduced from red primary 204 to red primary 234, green primary may be reduced from green primary 206 to green primary 236, and the blue primary may be reduced from blue primary 208 to blue primary 238.

In some embodiments, a color restoration algorithm may be utilized to shift the color primaries to the proper locations within the reduced color gamut. There are several color restoration algorithms available that may be used for color correction, such as, eeColor produced by Entertainment Experience, LLC, Reno, Nev. A color restoration algorithm may reposition the color primaries to correct locations within the color gamut, and adjust all colors within the color gamut accordingly. Color restoration may utilize visual models of color losses in sub-optimal ambient lighting to boost the color saturation of images, and/or restore the color saturation loss using a measure of average image colorfulness. Processing in such a manner may increase the brightness of the display without artifacts that may be introduced with the addition of a fourth sub-pixel. Additionally, a reduction in power consumption may be experienced in relation to utilizing a full sRGB color gamut.

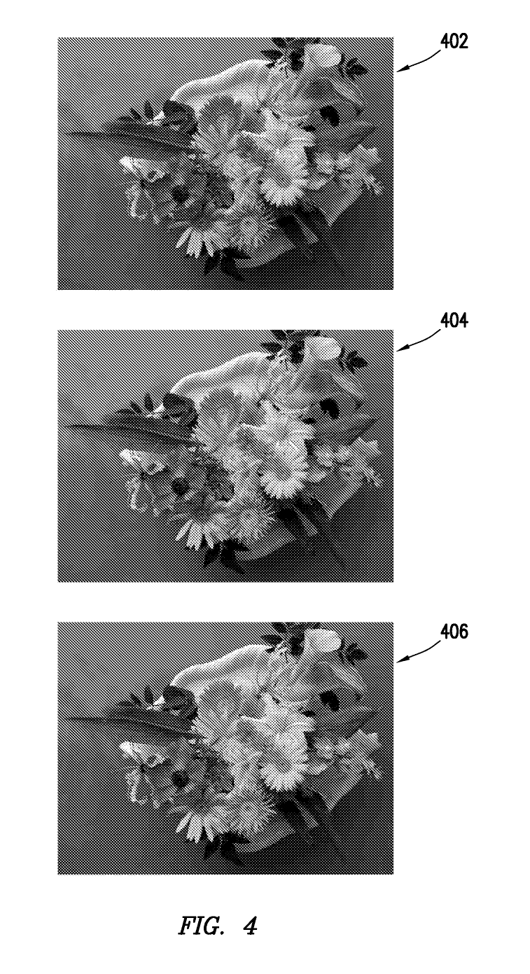

FIG. 4 illustrates the impact of sub-pixel openings shown in example configuration 330 of FIG. 3 on image saturation and utilization of a color restoration algorithm, in accordance with certain embodiments of the present disclosure. Original image 402 may be an image displayed on LCD 114 discussed with reference to FIG. 1. Original image 402 may be based on a sRGB color gamut, such as color gamut 202 discussed with reference to FIG. 2. Modified image 404 may be based on sub-pixel openings in each RGB sub-pixel as shown in configuration 330 of FIG. 3, e.g., approximately Uᵣ=0.2, U_{g}=0.3, and U_{b}=0.1, or openings approximately 0.3/0.2/0.1. In some embodiments, modified image 404 may be produced utilizing less power than original image 402 due in part to the brightness and/or luminance increase provided by the respective sub-pixel openings. Restored image 406 may be based on a color restoration algorithm applied to modified image 404. Thus, through the use of sub-pixel openings and a color restoration algorithm, restored image 406 may be displayed on LCD 114 utilizing less power than original image 402 with small or negligible impact on user experience.

In some embodiments, the size of the sub-pixel openings may be proportional across the entire LCD 114. In this case, any de-saturation would be proportional throughout LCD 114. For example, areas of LCD 114 where the image is saturated may receive approximately the same percentage of white as the areas where the colors are natural. However, in some embodiments, it may be advantageous to provide white light in the area where the colors are neutral and no white light where the colors are saturated. In this case, more white light may be input in the de-saturated regions and less in the saturated ones. In some embodiments, the size of the sub-pixel openings may be fixed and the variable white light may be provided by timing the sub-pixel openings such that white light passing would be sufficient.

In some LCD specifications, the RGB color primary coordinates and the D65 illuminant white point may be predefined. For example, the D65 illuminant may be defined as a color temperature of approximately 6500 Kelvin (K). In some embodiments, the white color point may be shifted away from approximately 6500K to adjust brightness to a higher value while reducing power consumption. For example, screen content may be monitored to determine the information or data displayed and the white point may be adjusted accordingly. For another example, if email or text reading is the primary content on LCD, the white to black contrast may be maximized. As a further example, when images are displayed, the white color point may shift accordingly. In both cases, the white color point may be adjusted to maximize brightness while still maintaining desirable visual experience.

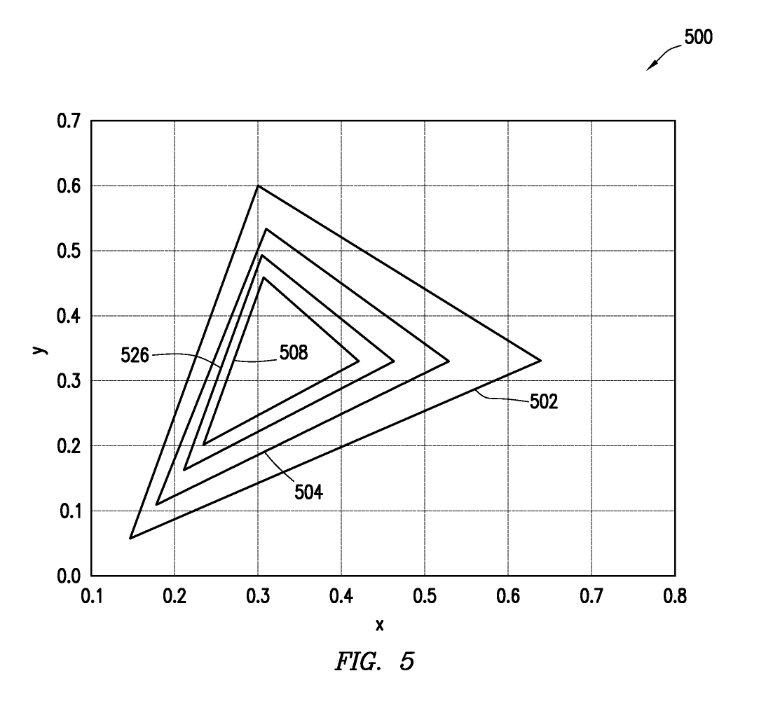

FIG. 5 illustrates an example xy chromaticity diagram 500 for LCD color optimization utilizing a common factor (U) for sub-pixel openings, in accordance with certain embodiments of the present disclosure. In some embodiments, each of the sRGB colorants may be diluted by the white of the D65 illuminant by a common factor, U. By using the common factor, U, each of the sub-pixel openings (shown with reference to FIG. 3) may be approximately equal in area. Thus, the amount of dilution and hence, the gain in luminance and loss of saturation may be based on a common factor, U, which may be the same factor applied to each color sub-pixel.

In some embodiments, initial color gamut 502, e.g., approximately U=0, may be approximately the sRGB color gamut discussed with reference to FIG. 2. However, if initial color gamut 502 is maximized to include more area than the sRGB color gamut, then more white illuminant, e.g., a larger sub-pixel opening, may be utilized without loss of color quality. Such a configuration may result in increased brightness and corresponding increased power savings. For example, initial color gamut 502 may correspond with AdobeRGB color primaries, which, with a sub-pixel opening, may reduce the color gamut to the sRGB color gamut. In some embodiments, the Quantum Dot systems, produced by Nanosys, Inc., Palo Alto, Calif., may be utilized to increase the initial color gamut by producing more pure green and red starting primaries. The Quantum Dot system may not use a white backlight but rather a blue LED backlight with no phosphor, which may be more efficient than a white backlight. Use of the Quantum Dot system may provide additional brightness increase and power savings.

In some embodiments, color gamut 504 may correspond to a common factor of approximately U=0.1. Color gamut 506 may correspond to a common factor of approximately U=0.2. Color gamut 508 may correspond to a common factor of approximately U=0.3.

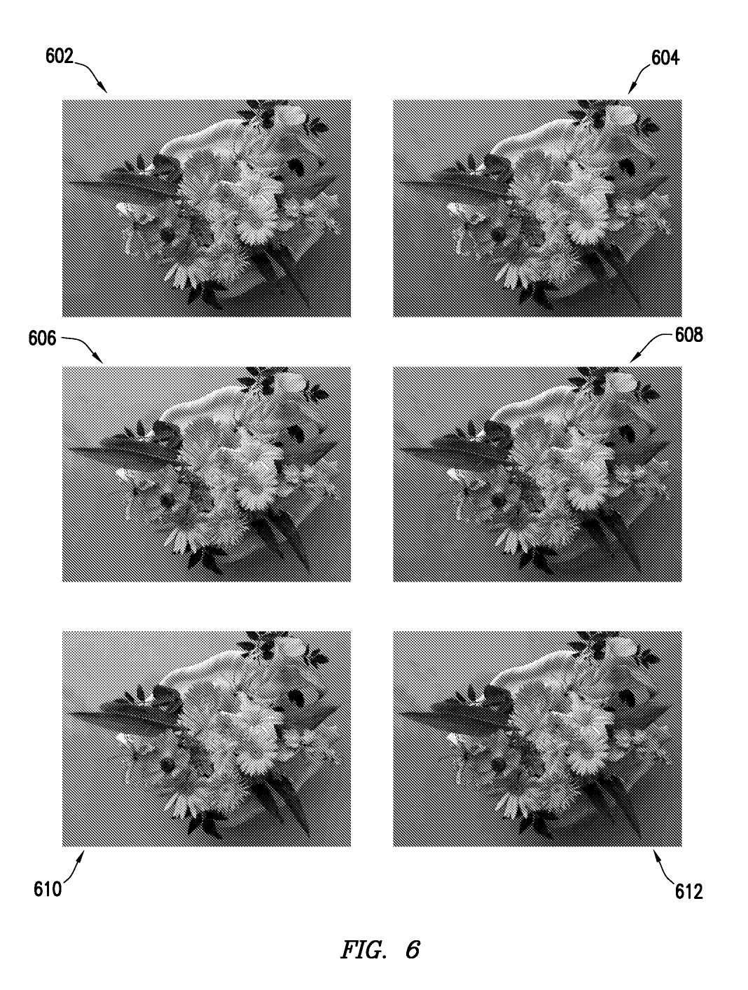

FIG. 6 illustrates an example impact of application of various common factors (U) for sub-pixel openings on saturation of an image and impact of utilization of a color restoration algorithm, in accordance with certain embodiments of the present disclosure. As discussed above, as the color gamut reduces, images displayed may become de-saturated. By utilizing a color restoration algorithm, e.g., eeColor, the color primaries may be adjusted and the image color saturation may appear to increase. Images illustrated in FIG. 6 may be based on original image 402, shown in FIG. 4, and may be an image displayed on LCD 114 discussed with reference to FIG. 1. Original image 402 may be based on a sRGB color gamut, such as color gamut 202 discussed with reference to FIG. 2 or color gamut 502 discussed with reference to FIG. 5.

In some embodiments, modified image 602 may illustrate the impact of a sub-pixel opening in each of the RGB sub-pixels of common factor approximately U=0.1. Modified image 602 may correspond to color gamut 504 shown on FIG. 5. Restored image 604 may illustrate the impact of a color restoration algorithm to adjust the color primaries for modified image 602. Similarly, modified image 606 may illustrate the impact of a sub-pixel opening of common factor approximately U=0.20. Modified image 606 may correspond to color gamut 506. Restored image 608 may illustrate the impact of a color restoration algorithm on modified image 606. Modified image 610 may illustrate the impact of a sub-pixel opening of common factor approximately U=0.30. Modified image 610 may correspond to color gamut 508. Restored image 612 may illustrate the impact of a color restoration algorithm on modified image 610. Accordingly, in some embodiments, increasing brightness by utilizing sub-pixel openings with a color restoration algorithm may result in an image display acceptable to a user while decreasing power required. The following table illustrates the potential power savings based on both the approximately 0.2/0.3/0.1 configuration (configuration 330 of FIG. 3) and a configuration with common factor approximately U=0.2:

| | | | Potential |
|---|---|---|---|
| | | | Power |
| Method | x | y | Savings |
| Original sRGB R | 0.64 | 0.33 | none |
| Original sRGB G | 0.30 | 0.60 | none |
| Original sRGB B | 0.15 | 0.06 | none |
| sRGB R (.2/.3/.1 configuration) | 0.463 | 0.329 | 33% |
| sRGB G (.2/.3/.1 configuration) | 0.307 | 0.458 | 33% |
| sRGB B (.2/.3/.1 configuration) | 0.186 | 0.119 | 33% |
| sRGB R (U = .2 configuration) | 0.52 | .30 | 29% |
| sRGB G (U = .2 configuration) | .3 | .52 | 29% |
| sRGB B (U = .2 configuration) | .18 | .12 | 29% |

In some embodiments, power savings may be a function of the initial color gamut because the amount of white that may be added may increase as the initial color gamut increases. Additionally, utilizing a white point other than the D65 illuminant may also allow an increased initial color gamut and improve power savings as discussed with reference to FIG. 5. For example, the Quantum Dot system may be utilized to increase the initial color gamut by producing more pure green and red starting primaries. As noted above, the Quantum Dot system may not use a white backlight 116 but rather a blue LED backlight with no phosphor, which may be more efficient than a white backlight. The Quantum Dot system may allow for larger sub-pixel openings and maintain negligible effect on the user experience. The following table illustrates the potential power savings for the Quantum Dot system based on both an approximately 0.35/0.45/0.3 configuration and a configuration with common factor approximately U=0.2:

| | | | Potential |
|---|---|---|---|
| | | | Power |
| Method | x | y | Savings |
| Original Quantum Dot R | 0.64 | 0.33 | none |
| Original Quantum Dot G | 0.30 | 0.60 | none |
| Original Quantum Dot B | 0.15 | 0.06 | none |
| Quantum Dot R | 0.412 | 0.2898 | 45% |
| (.35/.45/.3 configuration) | | | |
| Quantum Dot G | 0.2717 | 0.3879 | 45% |
| (.35/.45/.3 configuration) | | | |
| Quantum Dot B | 0.2096 | 01626 | 45% |
| (.35/.45/.3 configuration) | | | |
| Quantum Dot R | 0.412 | 0.2898 | 35% |
| (U = .2 configuration) | | | |
| Quantum Dot G | 0.2717 | 0.3879 | 35% |
| (U = .2 configuration) | | | |
| Quantum Dot B | 0.2096 | 01626 | 35% |
| (U = .2 configuration) | | | |

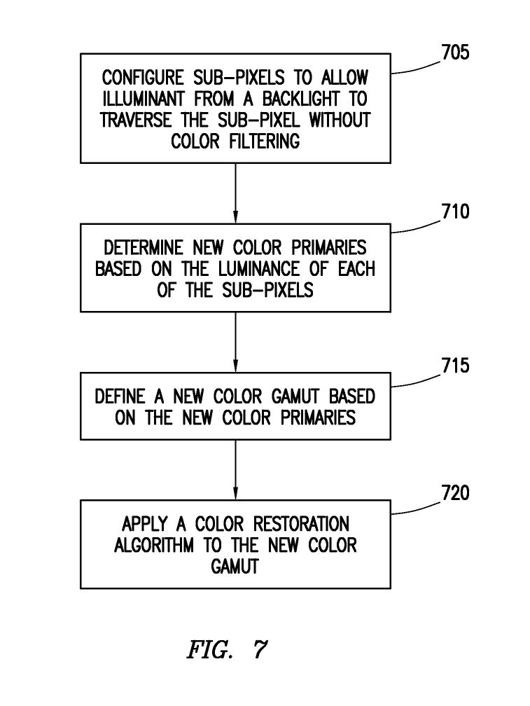

FIG. 7 illustrates a flow chart for an example method 700 for LCD 114 color optimization, in accordance with certain embodiments of the present disclosure. The steps of method 700 may be performed by various computer programs, models or any combination thereof. The programs and models may include instructions stored on a computer-readable medium and operable to perform, when executed, one or more of the steps described below. The computer-readable medium may include any system, apparatus or device configured to store and/or retrieve programs or instructions such as a microprocessor, a memory, a disk controller, a compact disc, flash memory or any other suitable device. The programs and models may be configured to direct a processor or other suitable unit to retrieve and/or execute the instructions from the computer readable media. For example, method 700 may be executed by processor 102, graphics system 114, brightness and color module 112, a user, and/or other suitable source. For illustrative purposes, method 700 may be described with respect to LCD 114 of FIG. 1; however, method 700 may be used for color optimization of any suitable LCD.

Although FIG. 7 discloses a particular number of steps to be taken with respect to method 700, method 700 may be executed with greater or lesser steps than those depicted in FIG. 7. In addition, although FIG. 7 discloses a certain order of steps to be taken with respect to method 700, the steps comprising method 700 may be completed in any suitable order.

At step 705, method 700 may configure sub-pixels of an LCD, such as LCD 114, to allow light from a backlight, such as backlight 116, to traverse the sub-pixel without color filtering. For example, openings may be made in some or all of the sub-pixels of LCD 114 to allow light from backlight 116 to pass through unfiltered to the display surface of LCD 114. As another example, as discussed with reference to FIG. 3, only some of the sub-pixels may have an opening based on color primaries, such as blue sub-pixels, red sub-pixels, green sub-pixels, and/or any other suitable subset of sub-pixels. The size of the openings for each of the sub-pixels or sets of sub-pixels may be uniform or may be different. For example, sub-pixel openings in each RGB sub-pixel may be configured as shown in configuration 330 of FIG. 3, e.g., approximately Uᵣ=0.2, U_{g}=0.3, and U_{b}=0.1, or openings approximately 0.3/0.2/0.1. As another example, the size of the openings may be based on a common factor, U, as discussed with reference to FIG. 5.

At step 710, method 700 may determine new color primaries based on the luminance of each of the sub-pixels configured to allow light from the backlight to pass through. For example, as discussed with reference to FIG. 3, new RGB color primaries may be determined based on the original luminance, the size of the opening, and the luminance of the D65 illuminant.

At step 715, method 700 the new color primaries may be utilized to define a new color gamut. For example, with reference to FIG. 2, the new color primaries may be utilized to define new color gamut 232 from original sRGB color gamut 202.

At step 720, method 700 may apply a color restoration algorithm to the new color gamut. For example, eeColor may be applied to color gamut 232. The color restoration algorithm may adjust all colors in color gamut 232 and restore the color saturation such that the restored image may approximate the original image when viewed by a user.

Modifications, additions, or omissions may be made to method 700 without departing from the scope of the present disclosure. For example, the order of the steps may be performed in a different manner than that described and some steps may be performed at the same time. For example, step 715 and step 720 may be performed simultaneously. Additionally, each individual step may include additional steps without departing from the scope of the present disclosure. For example, step 715 may be preformed before or after step 710 without departing from the scope of the present disclosure.

Although the present invention and its advantages have been described in detail, it should be understood that various changes, substitutions and alternations can be made herein without departing from the spirit and scope of the invention as defined by the following claims.

What is claimed is:

1. A method for liquid crystal display (LCD) brightness and color optimization comprising:
configuring a sub-pixel of a LCD to allow light from a backlight to traverse the sub-pixel unfiltered to a display surface of the LCD;
determining a color primary based on the amount of light from the backlight that traverses the sub-pixel unfiltered, the color primary defining a portion of a color gamut available to the LCD, the color gamut having a plurality of colors; and
applying a color restoration algorithm to adjust the plurality of colors in the color gamut.

2. The method of claim 1, wherein adjusting the plurality of colors within the color gamut comprises restoring saturation of the plurality of colors such that the color gamut approximates a standard red, green, and blue (sRGB) color gamut.

3. The method of claim 1, wherein applying a color restoration algorithm comprises defining an adjusted color primary.

4. The method of claim 1, wherein configuring the sub-pixel comprises defining an opening in the sub-pixel.

5. The method of claim 4, wherein defining an opening in the sub-pixel is based on a reduction in power usage.

6. The method of claim 1, further comprising:
configuring a plurality of sub-pixels of the LCD to allow light from a backlight to traverse each of the sub-pixels unfiltered to the display surface of the LCD;
determining a plurality of color primaries based on the amount of light from the backlight that traverses each of the plurality of sub-pixels unfiltered, the plurality of color primaries defining a portion of a color gamut available to the LCD, the color gamut having a plurality of colors.

7. The method of claim 6, wherein configuring the plurality of sub-pixels comprises defining an opening in each of the plurality of sub-pixels.

8. The method of claim 7, wherein the plurality of sub-pixels comprise a plurality of red sub-pixels, a plurality of green sub-pixels, and a plurality of blue sub-pixels, the opening in each of the plurality of red sub-pixels is based on a first factor, the opening in each of the plurality of green sub-pixels is based on a second factor, and the opening in each of the plurality of blue sub-pixels is based on a third factor.

9. The method of claim 7, wherein the opening in each of the plurality of sub-pixels is based on a common factor.

10. A liquid crystal display (LCD) comprising:
a sub-pixel of the LCD configured to allow light from a backlight to traverse the sub-pixel unfiltered to a display surface of the LCD; and
a processor configured to:
determine a color primary based on the amount of light from the backlight that traverses the sub-pixel unfiltered, the color primary defining a portion of a color gamut available to the LCD, the color gamut having a plurality of colors; and
apply a color restoration algorithm to adjust the plurality of colors in the color gamut.

11. The display of claim 10, wherein adjusting the plurality of colors within the color gamut comprises restoring saturation of the plurality of colors such that the color gamut approximates a standard red, green, and blue (sRGB) color gamut.

12. The display of claim 10, wherein applying a color restoration algorithm comprises defining an adjusted color primary.

13. The display of claim 10, wherein the sub-pixel comprises an opening in the sub-pixel.

14. The display of claim 13, wherein the opening in the sub-pixel is based on a reduction in power usage.

15. The display of claim 10, further comprising:
a plurality of sub-pixels of the LCD configured to allow light from a backlight to traverse each of the sub-pixels unfiltered to the display surface of the LCD; and
wherein the processor is further configured to:
determine a plurality of color primaries based on the amount of light from the backlight that traverses each of the plurality of sub-pixels unfiltered, the plurality of color primaries defining a portion of a color gamut available to the LCD, the color gamut having a plurality of colors.

16. The display of claim 15, wherein the plurality of sub-pixels have an opening in each of the plurality of sub-pixels.

17. The display of claim 16, wherein the plurality of sub-pixels comprise a plurality of red sub-pixels, a plurality of green sub-pixels, and a plurality of blue sub-pixels, the opening in each of the plurality of red sub-pixels is based on a first factor, the opening in each of the plurality of green sub-pixels is based on a second factor, and the opening in each of the plurality of blue sub-pixels is based on a third factor.

18. The display of claim 16, wherein the opening in each of the plurality of sub-pixels is based on a common factor.

19. An information handling system comprising:
a liquid crystal display (LCD) having a sub-pixel configured to allow light from a backlight to traverse the sub-pixel unfiltered to a display surface of the LCD;
a memory;
a processor communicatively coupled to the LCD and the memory; and
a computer-readable medium communicatively coupled to the processor and having stored thereon instructions configured to, when executed by the processor:
determine a color primary based on the amount of light from the backlight that traverses the sub-pixel unfiltered, the color primary defining a portion of a color gamut available to the LCD, the color gamut having a plurality of colors; and
apply a color restoration algorithm to adjust the plurality of colors in the color gamut.

20. The system of claim 19, wherein adjusting the plurality of colors within the color gamut comprises restoring saturation of the plurality of colors such that the color gamut approximates a standard red, green, and blue (sRGB) color gamut.
